(19) United States
(12) Patent Application Publication
(10) Pub. No.: US 2023/0397760 A1
(43) Pub. Date: Dec. 14, 2023

(54) TWO PIECE CAST IRON FIRE PIT COOKTOP

(71) Applicant: Lamplight Farms Incorporated, Menomonee Falls, WI (US)

(72) Inventors: Lucas Henry Zeitler, Pickerington, OH (US); Daniel J. Knight, Murfreesboro, TN (US); Kyle Ressler, West Bend, WI (US); Andrew Schauer, Waukesha, WI (US)

(21) Appl. No.: 18/140,228

(22) Filed: Apr. 27, 2023

Related U.S. Application Data
(60) Provisional application No. 63/350,486, filed on Jun. 9, 2022.

(51) Int. Cl. A47J 33/00; A47J 37/07

(52) U.S. Cl. CPC A47J 33/00; A47J 37/0772; F24B 1/003

(57) ABSTRACT

A multi-piece cooktop compatible with various firepits for creating a firepit assembly.

### CROSS-REFERENCE TO RELATED CASES

This application claims the benefit of U.S. provisional patent application Ser. No. 63/350,486, filed on Jun. 9, 2022, and incorporates such provisional application by reference into this disclosure as if fully set out at this point.

### FIELD OF THE INVENTION

The present invention relates to outdoor cooking and outdoor fire pits. More particularly, the invention relates to a multi-piece cooktop that is configured for use with fire pits and accessories of various configurations.

### BACKGROUND OF THE INVENTION

Outdoor fire pits have, in the past, been permanent fixtures built from rock, concrete, metals, or other resilient and heavy materials. Often a fire pit is built directly on the ground and is not readily portable. Recently, fire pits have been developed that may be somewhat portable and may be used to provide warmth for users surrounding the fire pit. It is desirable to increase the functionality of a fire pit as well as keep production costs low.

### SUMMARY OF THE INVENTION

The fire pit assembly of the invention allows for a user to utilize a fire pit for cooking by utilizing a two piece cook top adapted to be received on the fire pit. In one embodiment, the two piece cook top is configured so that it may be provided for at least two differently sized fire pit products.

In greater detail, an outer donut style cook top is designed to fit onto a fire pit or onto a screen accessory of a fire pit. The cook top includes a cook to top ring and a center piece. The center piece, or donut hole, of the cook top is designed to fit in the hole of the cook top ring. The two piece design offers many benefits, including easy access to tend the fire of the fire pit, easy access to the fire pit to add wood, an ability to easily change cooking surfaces, e.g., griddle, grate, pan, sear plate, dutch oven, etc. The outer donut not only provides additional cooking area, it also helps contain grease, provides a cooler area for food resting, and, with the supplied trivet provides a large serving area. The cook top is designed to fit various components including a relatively smaller fire pit, a relatively smaller fire pit screen, a relatively larger fire pit, and a relatively larger fire pit screen.

In greater detail, a fire pit and multi-piece cooktop assembly includes a fire pit having a fire pit body defining a chamber that is partially defined by an inner chamber wall having an upper end and defining a plurality of apertures, and partially defined by a fuel grate defining a plurality of apertures. The fire pit has an outer wall having an upper end that surrounds the inner chamber wall. The fire pit has a top panel between the upper end of the inner chamber wall and the upper end of the outer wall. The fire pit body is supported by a stand having a support ring supported by a plurality of legs.

A ring is located above the inner chamber wall and above the top panel. The ring has an inner vertical ring portion and an outer horizontal ring portion.

An accessory may be provided. The accessory has an accessory body. The accessory body has an upper surface, a lower surface and a width. In one embodiment, the accessory is a screen member. The lower surface may be received within the upper end of the inner chamber wall of the chamber.

A multi-piece cooktop is provided having an inner cooking member received within a ringed cooking member. The inner cooking member defines a cooking surface having a width, and a bottom surface having a width. The width of the cooking surface may be a diameter. The inner cooking member has an outer edge between the cooking surface and the bottom surface. In one embodiment the cooking surface is circular. The cooking surface preferably defines a plurality of alternating raised members and channels. The width of the bottom surface is smaller than the width of the cooking surface such that the outer edge has an outward slant. The outward slant of the outer edge may be approximately 15-60 degrees from vertical. In some embodiments the outward slant is about 30 degrees from vertical. A handle extends upwardly and outwardly from the outer edge of the inner cooking member.

The ringed cooking member has a base defining a surrounding cooking surface and a surrounding bottom surface. The surrounding cooking surface defines an inner cooking surface edge defining a cooking surface orifice. The ringed cooking member has a circular perimeter. The surrounding cooking surface defines an outer cooking surface edge. The surrounding cooking surface is surround by upwardly extending sides defining a rim. A first handle and a second handle extend above the rim. A surrounding channel is between the outer cooking surface edge and the upwardly extending sides. The surrounding channel defines an inwardly sloping inner surface. In one embodiment, the cooking surface orifice is circular. In one embodiment, cooking surface orifice is centered within the surrounding cooking surface. The surrounding bottom surface defines a bottom surface inner edge that surrounds a bottom surface orifice. An orifice perimeter extends from the inner cooking surface edge of the cooking surface orifice to the bottom surface inner edge of the bottom surface orifice. The cooking surface orifice is larger than the bottom surface orifice such that the orifice perimeter has an outward slant. The outward slant of the orifice perimeter may be approximately 15-60 degrees from vertical. In some embodiments, it is about 30 degrees from vertical.

The outer edge of the inner cooking member is sized to be matingly received within the orifice perimeter of the ringed cooking member. When the outer edge of the inner cooking member is matingly received within the orifice perimeter of the ringed cooking member, the surrounding cooking surface of the inner cooking member and the cooking surface of the ringed cooking member are substantially co-planar. “Substantially co-planar” is defined as having a deviation of less than ⅛″ inch;

The multi-piece cooktop is sized to be received on the upper surface of the accessory body. The bottom surface inner edge of the bottom surface orifice of the ringed cooking member is sized to be received on the ring of the firepit and the inwardly sloped inner surface of the surrounding channel is sized to be received on the ring of the firepit.

Therefore, it can be seen that the multi-piece cooktop of the invention is adapted for use on fire pits of various configurations, both with and without an accessory such as a screen member.

### BRIEF DESCRIPTION OF THE DRAWINGS

FIG. 1 is a photographic perspective view of a two piece fire pit cooktop located on a screen accessory on a small fire pit;

FIG. 2 is a schematic perspective view of a two piece fire pit cooktop located on a top panel of a small fire pit;

FIG. 3 is a schematic perspective view of a two piece fire pit cooktop located on a screen accessory on a small fire pit;

FIG. 4 is schematic perspective view of the small fire pit of FIGS. 1 and 2;

FIG. 5 is a schematic perspective view of a two piece fire pit cooktop located on a top panel of a large fire pit;

FIG. 6 is a schematic perspective view of a two piece fire pit cooktop located on a screen accessory on a large fire pit;

FIG. 7A is a perspective view of the two piece fire pit cooktop shown with the interior cooking surface removed from the surrounding ringed cooking surface;

FIG. 7B is an enlarged elevation view of an outer edge of the inner cooking member of FIG. 7A showing an angle α of the outer edge with respect to vertical;

FIG. 7C is an enlarged elevation view showing an inner perimeter, inner cooking surface edge and bottom surface orifice of the base of the inner cooking member of FIG. 7A;

FIG. 8 is a perspective view of the two piece fire pit cooktop shown with an alternate embodiment of interior cooking surface having a first and second handle receiving orifices;

FIG. 9 is an enlarged bottom perspective view of the alternate embodiment of the interior cooking surface of FIG. 8;

FIG. 10 is a perspective view of the two piece fire pit cooktop with the alternative embodiment of interior cooking surface of FIG. 8 shown with a handle received in one of the first and second handle receiving orifices;

FIG. 11 is a perspective view of the two piece fire pit cooktop shown with an interior grate piece and a trivet sized to be received in the orifice defined by the ringed cooking surface;

FIG. 12 is an exploded perspective view of the two piece fire pit cooktop of FIG. 8 and the trivet and grate piece of FIG. 11;

FIG. 13 is a perspective view of the ringed cooking surface of FIG. 7 defining a cooking surface orifice;

FIG. 14 is an enlarged perspective view of the trivet of FIGS. 11 and 12.

### DETAILED DESCRIPTION OF THE PREFERRED EMBODIMENTS

Referring now to the figures, shown is a fire pit and multi-piece cook top assembly, designated generally 10. Assembly 10 includes fire pit 20 having a fire pit body 22. Fire pit body 22 defines chamber 24 (see, e.g., FIG. 4). Chamber 24 is partially defined by inner chamber wall 26. Inner chamber wall 26 has upper end 28 and defines a plurality of apertures 30. Chamber 24 is also partially defined by fuel grate 32. Fuel grate 32 also preferably defines a plurality of apertures 34. Fire pit 20 has outer wall 36 that surrounds inner chamber wall 26. Outer wall 36 has upper end 38. Fire pit 20 has top panel 40 that is between upper end 28 of inner chamber wall 26 and upper end 38 of outer wall 36. Fire pit body 22 is supported by stand 42. Stand 42 includes support ring 44 that is supported by a plurality of legs 46.

Ring 50 is located above inner chamber wall 26 on top panel 40. Ring 50 preferably has inner vertical ring portion 52 and outer horizontal ring portion 54.

In one embodiment, assembly 10 includes accessory 60. Accessory 60 includes accessory body 62 having an upper surface, a lower surface, and a width. In one embodiment, accessory 60 is screen member 70. The lower surface of accessory 60 may be received within upper end 28 of inner chamber wall 26 of chamber 24.

Multi-piece cook top is designated generally 80. Multi-piece cook top 80 includes inner cooking member 90 and ringed cooking member 110.

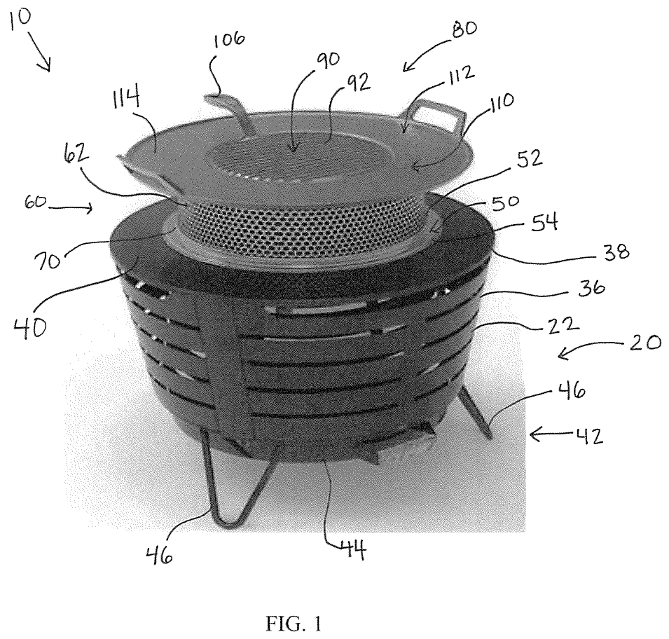

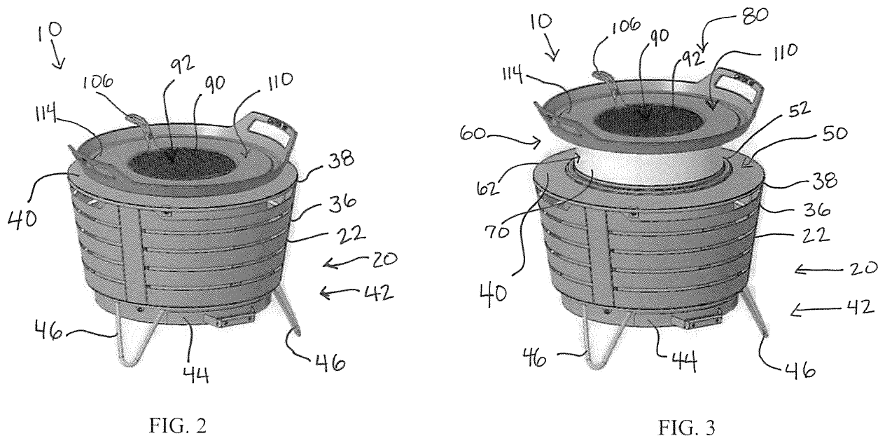

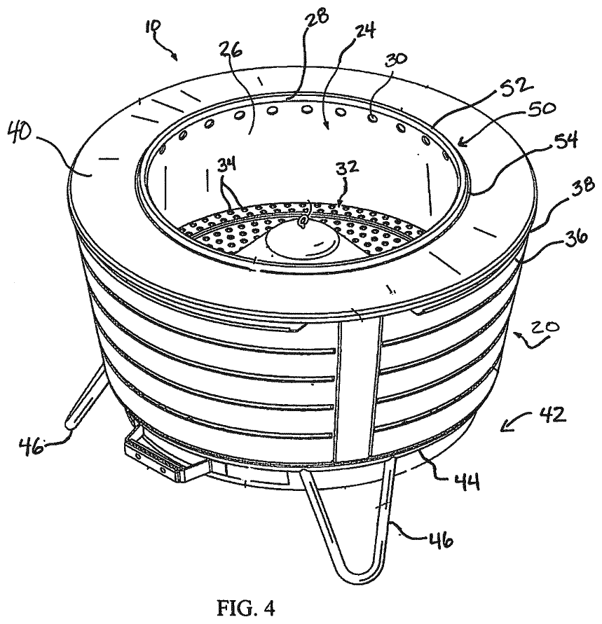

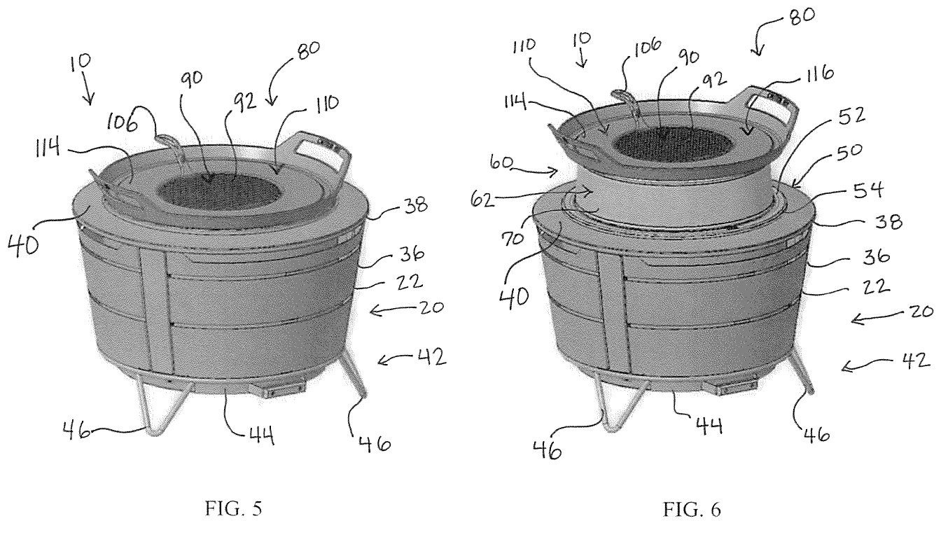

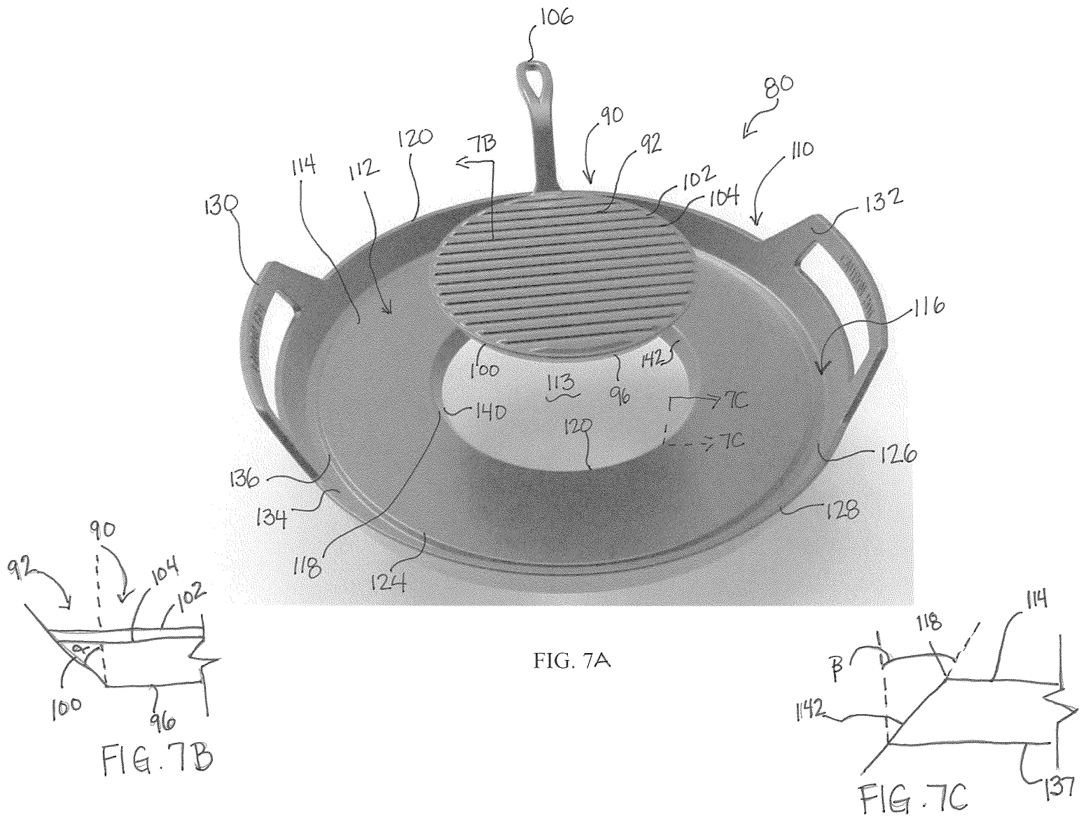

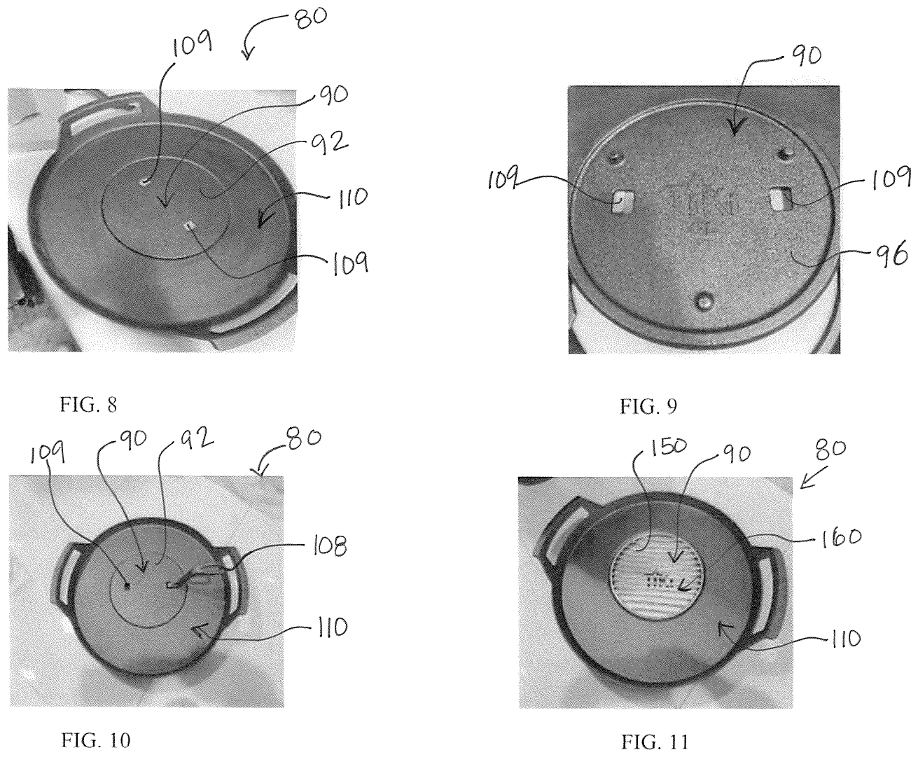

Inner cooking member 90 defines cooking surface 92 having a width. Inner cooking member 90 additionally has bottom surface 96 having a width. In one embodiment, the width of cooking surface 92 is a diameter. Inner cooking member 90 additionally has outer edge 100 (FIG. 7) between cooking surface 92 and bottom surface 96. In one embodiment, cooking surface 92 is circular. In one embodiment, cooking surface 92 defines a plurality of raised members 102 of alternating raised members 102 and channels 104 (FIG. 7A). The width of bottom surface 96 is smaller than the width of cooking surface 92 such that outer edge 100 has an outward slant that forms an angle α (FIG. 7B). Angle α defining the outward slant of outer edge 100 may be approximately 15-60 degrees from vertical. In some embodiments angle α is about 30 degrees. In one embodiment (e.g., FIGS. 1-3, 5, 6, 7A), integral handle 106 extends upwardly and outwardly from outer edge 100 of inner cooking member 90. In another embodiment, handle 108 is a separate piece and is adapted to be received in handle orifices 109 formed in inner cooking member 90 (see, e.g., FIGS. 8-10).

Referring now primarily to FIG. 7A, ringed cooking member 110 has base 112 that defines cooking orifice 113 having an upper surrounding cooking surface 114 and a lower surrounding bottom surface 116. Surrounding cooking surface 114 defines inner cooking surface edge 118 that defines cooking surface orifice 120. In one embodiment, ringed cooking member 110 has a circular cooking surface orifice 120. Surrounding cooking surface 114 defines outer cooking surface edge 124. Surrounding cooking surface 114 is surrounded by upwardly extending sides 126. Upwardly extending sides 126 define rim 128. First handle 130 extends above rim 128. Second handle 132 also extends above rim 128. Surrounding channel 134 is between outer cooking surface edge 124 and upwardly extending sides 126. Surrounding channel 134 defines inwardly sloping inner surface 136. In one embodiment, cooking surface orifice 120 is circular. In one embodiment, cooking surface orifice 120 is centered within surrounding cooking surface 114. Surrounding bottom surface 116 (FIG. 7C) defines bottom surface inner edge 138 that surrounds bottom surface orifice 140. Orifice perimeter 142 extends from inner cooking surface edge 118 of cooking surface orifice 120 to bottom surface inner edge 138 of bottom surface orifice.

Cooking surface orifice 120 is larger than bottom surface orifice 140 such that orifice perimeter 142 has an outward slant. The outward slant of orifice perimeter 142 defines an angle β that may be approximately 15-60 degrees from vertical. In some embodiments, angle β is about 30 degrees.

Outer edge 100 of inner cooking member 90 is sized to be matingly received within orifice perimeter 142 of ringed cooking member 110. When outer edge 100 of inner cooking member 90 is matingly received within orifice perimeter 142 of ringed cooking member 110, surrounding cooking surface 114 of ringed cooking member 110 and cooking surface 92 of inner cooking member 90 are substantially co-planar where substantially co-planar is defined as having a deviation of less than ⅛ inch.

In another embodiment of the invention, inner cooking member 90 is a cooking grate 150 sized to be received in cooking orifice 113. Ringed cooking member 110 may define interior projections 152 (see, e.g., FIG. 13) for providing a surface for receiving cooking grate 150 within cooking orifice 113.

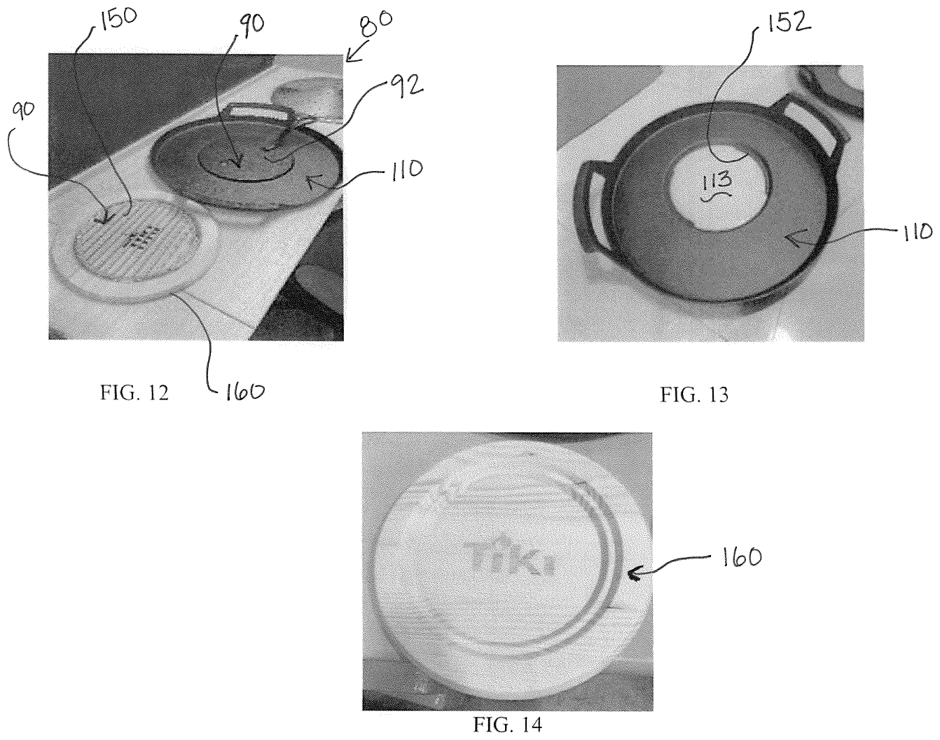

In one embodiment, removable trivet 160 may be provided and adapted to be stored beneath cooking grate 150 (see, e.g., FIGS. 11, 12, and 14).

In one embodiment, multi-piece cooktop 80 is sized to be received on the upper surface of accessory body 62. In one embodiment, bottom surface inner edge 138 of bottom surface orifice 140 of ringed cooking member 110 is sized to be received on ring 50 of fire pit 20, e.g., on a relatively large embodiment of the fire pit 20. In one embodiment, inwardly sloped inner surface 136 of surrounding channel 134 is sized to be received on ring 50 of fire pit 20, e.g., on a relatively small embodiment of fire pit 20.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)— (a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A multi-piece cooktop comprising:
a ringed cooking member defining a cooking orifice, said ringed cooking member having a ringed cooking surface, a bottom surface and an orifice perimeter, said orifice perimeter is angled with respect to vertical by an angle β;
an inner cooking member received in said cooking orifice, said inner cooking member defining a cooking surface, a bottom surface and an outer edge, wherein said outer edge is angled with respect to vertical by an angle α;
wherein said angle α and said angle β are between 15 degrees and 60 degrees from vertical;
wherein when said inner cooking member is received within said cooking orifice of said ringed cooking member, said ringed cooking surface of said ringed cooking member and said cooking surface of said inner cooking member are substantially co-planar.

2. The multi-piece cooktop of claim 1 wherein said ringed cooking member is circular.

3. The multi-piece cooktop of claim 1 wherein said inner cooking member is circular.

4. The multi-piece cooktop of claim 1 wherein said inner cooking member defines a plurality of alternating raised members and channels.

5. The multi-piece cooktop of claim 1 wherein said inner cooking member defines an integral handle.

6. The multi-piece cooktop of claim 1 wherein said inner cooking member defines a handle receiving orifice for receiving a handle.

7. The multi-piece cooktop of claim 1 wherein:
said inner cooking member defines a grate; and
said ringed cooking member defines interior projections for receiving and supporting said grate.

8. The multi-piece cooktop of claim 1 wherein said angle α is approximately 30 degrees.

9. The multi-piece cooktop of claim 1 wherein said angle β is approximately 30 degrees.

10. A firepit assembly including a multi-piece cooktop compatible with a small firepit and a large firepit, the firepit assembly comprising:
the multi-piece cooktop having a ringed cooking member defining a ringed cooking surface and a cooking orifice, a bottom surface defining a bottom surface inner edge where said bottom surface meets said cooking orifice, wherein said ringed cooking surface defines an outer cooking surface edge surrounded by a surrounding channel defining an inner surface, said multi-piece cooktop having an inner cooking member received in said cooking orifice, said inner cooking member defining a cooking surface, a bottom surface and an outer edge;
wherein the small firepit is configured for selectively receiving said multi-piece cooktop by said small firepit having a top panel supporting a ring, wherein said inner surface of said surrounding channel is sized to be received on said ring of said small fire pit;
wherein the large firepit is configured for selectively receiving said multi-piece cooktop by said large firepit having a top panel supporting a ring, wherein said bottom surface inner edge of said bottom surface of said ringed cooking member is sized to be received on said ring of said large fire pit.

11. The firepit assembly of claim 10 further comprising:
an accessory body on said top panel of said small firepit, said accessory body for supporting said multi-piece cooktop.

12. The firepit assembly of claim 11 wherein:
said accessory body is a screen member.

13. The firepit assembly of claim 10 wherein:
said ringed cooking member further defines an orifice perimeter, wherein said orifice perimeter is angled with respect to vertical by an angle β;
said inner cooking member is received in said cooking orifice, wherein said outer edge of said inner cooking member is angled with respect to vertical by an angle α;
wherein said angle α and said angle β are between 15 degrees and 60 degrees from vertical;
wherein, when said inner cooking member is received within said ringed cooking member, said ringed cooking surface of said ringed cooking member and said cooking surface of said inner cooking member are substantially co-planar.

14. The firepit assembly of claim 10 wherein said ringed cooking member is circular.

15. The firepit assembly of claim 10 wherein said inner cooking member is circular.

16. The firepit assembly of claim 10 wherein said inner cooking member defines a plurality of alternating raised members and channels.

17. The firepit assembly of claim 10 wherein said inner cooking member defines an integral handle.

18. The firepit assembly of claim 10 wherein said inner cooking member defines a handle receiving orifice for receiving a handle.

19. The firepit assembly of claim 10 wherein:
said inner cooking member defines a grate; and
said ringed cooking member defines interior projections for receiving and supporting said grate.

20. The firepit assembly of claim 10 wherein said angle α is approximately 30 degrees.

21. The firepit assembly of claim 10 wherein said angle β is approximately 30 degrees.
